(19) United States
(12) Patent Application Publication
(10) Pub. No.: US 2025/0241731 A1
(43) Pub. Date: Jul. 31, 2025

(54) METHOD FOR NON-INVASIVE COMPOSITE VENEERS

(71) Applicant: Marshall Hanson, Draper, UT (US)

(72) Inventor: Marshall Hanson, Draper, UT (US)

(21) Appl. No.: 18/429,252

(22) Filed: Jan. 31, 2024

(51) Int. Cl. A61C 5/85; A61C 5/60; A61C 13/00

(52) U.S. Cl. CPC A61C 5/85; A61C 5/60; A61C 13/0006

(57) ABSTRACT

A method for non-invasive veneers, including the step of placing a clear matrix around the front surface of a tooth, the matrix placed into the gingival sulcus and extending from the front surface of the tooth, adding a primary layer of resin to the tooth, the resin being heated prior to application and added to the tooth in the following order, each section of resin cured prior to adding resin in the subsequent region: the bottom of the tooth, the side of the tooth, and the front surface of the tooth, mechanically removing a portion of the primary layer of resin using an abrasive material, adding a secondary layer of resin, the secondary layer of resin being a different resin than previously applied, and polishing the secondary layer of resin.

### BACKGROUND OF THE INVENTION

### Field of the Invention

The present invention relates to dental procedures, specifically to a method of creating non-invasive veneers.

### Description of the Related Art

Human teeth change from use and as we age. Over time, chemical erosion and mechanical abrasion on the teeth slowly wear away at the enamel of the teeth, and the enamel accumulates external stains. Further, even if excellent care of the teeth is exercised, the dentin in the teeth becomes thicker and the white look teeth have slowly changes to yellow, and the fluid supply to the teeth wanes, causing the teeth to become more brittle and prone to cracking or chipping. Various techniques have been developed to try and counteract such changes regardless of whether those changes are permanent damage or simply cosmetic.

Dental veneers are a common type of cosmetic dentistry treatments used to improve the appearance of the teeth. Veneers are thin shells made to fit the shape and look of the tooth and are subsequently attached to the front surface of the teeth. Veneers cover up the front surface of the teeth when there are cosmetic imperfections, such as chips, cracks, and stains.

The process for veneers is invasive and involves the removal of enamel or even layers of the tooth under the enamel. After the material has been removed from the teeth, an impression is made and a porcelain veneer is created and later cemented to the tooth, or a plurality of small layers of resin are sequentially added to the tooth, building the removed material back up to a desired look, and then hardened in place once the desired look is achieved. Veneers are irreversible and are typically performed under local anesthesia.

Some improvements have been made in the field. Examples of references related to the present invention are described below in their own words, and the supporting teachings of each reference are incorporated by reference herein:

U.S. Pat. No. 9,877,800, issued to Silverman, discloses a non-invasive method for making a tooth veneer from composite resin material for a patient's tooth without tooth reduction, enamel removal or any invasive tooth preparation, comprising the steps of transferring an amount composite resin material on the patient's tooth without prior invasive tooth preparation; forming a preview veneer from the composite resin material directly on the tooth; requesting the patient to approve or disapprove the preview veneer; if approved, requesting the patient whether to have a first method veneer or a second method veneer. A kit for a non-invasive method of making a tooth veneer for a patient's tooth without tooth reduction, enamel removal or any invasive tooth preparation.

U.S. Pat. No. 10,952,815, issued to Mishaeloff, discloses a matrix adapted is for the specific tooth type, and is positioned on the tooth to covers the tooth, so that an injected curable material is encased by the matrix over the tooth. When the curable material has cured, the matrix is removed, resulting in a veneer on the tooth.

U.S. Pat. No. 11,311,358, issued to Vuillemot, discloses processes and devices for dental restorations employ molding tools that isolate individual tooth surfaces onto which dental composite material is to be applied and cured into individual cavities to prevent bonding of adjacent teeth. The processes and tools utilize matrix separators between teeth and a molding tool having matrix guide pockets that receive edges of the matrix separators to define the individual cavities.

W.O. Patent Application Publication No.: 2015/148692, by Clark, discloses methods for the restoration of a decayed portion of a tooth and dental matrices that may be used in the methods for the restoration of a decayed portion of a tooth are disclosed. Methods for direct elective composite additive crowning and veneering of teeth that may or may not have decay or previous restorations are also disclosed.

The inventions heretofore known suffer from a number of disadvantages which include having an unnatural look, being difficult to perform, serving as only a temporary replacement, being expensive, not stain resistant, being overly thin and/or bulky, being prone to damage, not holding shine, being time consuming to create, and requiring invasive and non-reversible techniques.

What is needed is a method of creating non-invasive veneers that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available methods. Accordingly, the present invention has been developed to provide a safe and efficient method for non-invasive veneers.

There may be a method for non-invasive veneers, which may include placing a strip around the front surface of a tooth, such that the tooth may be isolated from the surrounding teeth, filling a portion of the interior of the strip with a resin, curing the resin, and mechanically removing the resin, the step of adding a secondary layer of resin may be after the step of mechanically removing the resin, the step of mechanically removing the resin may include shaping the tooth into a desired shape, the step of mechanically removing the resin may include introducing heat to the resin, the step of filling the interior of the matrix with a resin may include heating the resin immediately before application, the step of filling an interior of the matrix with a resin may include overbuilding the resin on the tooth, the step of adding a secondary layer of resin may include wherein the resin used is a different resin than the resin previously applied, the strip may be a clear BoPET matrix, and the secondary resin may be weaker than the resin previously applied, however is more polish and color stable.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side perspective view of teeth with a BoPET matrix in place, according to one embodiment of the invention;

FIG. 2 is a side perspective view of teeth with overbuilt resin ready for the cutback step, according to one embodiment of the invention;

FIG. 3 is a side perspective view of teeth shaped naturally after the cutback step, according to one embodiment of the invention;

FIG. 4 is a flowchart of a method for non-invasive veneers, according to one embodiment of the invention;

FIG. 5 is a front elevational view of teeth prior to veneers, according to one embodiment of the invention;

FIG. 6 is a front elevational view of teeth after veneers, according to one embodiment of the invention;

FIG. 7 is a front elevational view of teeth, showing a step of an initial frame after a first overbuild, according to one embodiment of the invention;

FIG. 8 is a side perspective view of teeth, showing a step of a first cut back, according to one embodiment of the invention;

FIG. 9 is a side perspective view of teeth, showing a step of added tints and natural effects, according to one embodiment of the invention;

FIG. 10 is a side perspective view of teeth, showing a step of a filter composite placed over tints, according to one embodiment of the invention;

FIG. 11 is a front elevational view of teeth, showing a step of an overbuild of a clear layer, according to one embodiment of the invention;

FIG. 12 is a bottom plan view of teeth, showing a step of an overbuild of a clear layer, according to one embodiment of the invention;

FIG. 13 is a side perspective view of teeth, showing a step of final framing and shaping after an overbuild of a clear layer, according to one embodiment of the invention; and

FIG. 14 is a side perspective view of teeth, showing a step of a final finishing and polishing, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

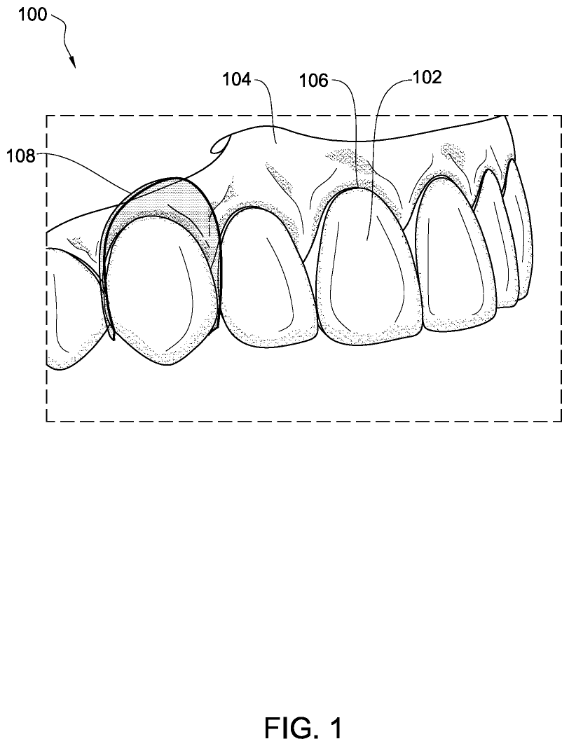

FIG. 1 is a side perspective view of teeth with a BoPET matrix in place, according to one embodiment of the invention. As shown, there is a mouth 100 of the patient, the mouth containing multiple teeth 102, the gums 104, the gumline 106 and a matrix 108.

The teeth 102 may be any individual tooth in need of repair and/or cosmetic touchup. The teeth 102 are measured such that a matrix 108 may be created/cut/formed/shaped to the specific teeth 102 that needs touch up and/or repair such that a seamless fit is made between the teeth 102 and the matrix 108. Generally the matrix is a BoPET matrix (i.e. composed of the material BoPET (Biaxially-oriented polyethylene terephthalate, sold commercially under the brand Mylar® by DuPont) or a similar material thereto). A BoPET matrix is a thin, flexible strip of clear/transparent plastic that is used in cosmetic dentistry to create a temporary separation between adjacent teeth during a dental restoration procedure. The BoPET matrix is placed around the tooth being restored and is held in place using a dental clamp or retainer. The BoPET matrix creates a barrier between the restored tooth and the adjacent teeth, which helps to prevent composite resin or other dental material from sticking to the adjacent teeth during the restoration process. This allows the dentist to sculpt the restoration material without interference from adjacent teeth, resulting in a more precise and natural-looking restoration. BoPET matrices are used in cosmetic dentistry for composite resin restorations, such as dental bonding or tooth-colored fillings. They are also used for other restorative procedures, such as crowns or veneers, to create a temporary separation between the teeth during preparation and impression taking. BoPET matrices are disposable and come in various sizes and shapes to accommodate different tooth sizes and restoration types.

BoPET is a type of polyester film that is known for its strength, durability, and chemical resistance. It is commonly used in a wide range of industries, including electronics, packaging, and printing. In cosmetic dentistry, it is used as a matrix material because it is biocompatible, meaning it is safe for use in the oral cavity, and it does not react with dental materials, such as composite resin or bonding agents. The transparency of BoPET allows the dentist to see the tooth being restored and to accurately place the matrix in the desired position. The flexibility of BoPET allows it to conform to the shape of the teeth, creating a tight seal around the tooth being restored, and the adjacent teeth. This helps to prevent composite resin or other dental materials from sticking to the adjacent teeth during the restoration process.

A mold and scan are also made of the teeth 102 such that a tooth model and blueprint may be made. Cosmetic dental procedures often involve the use of digital imaging technologies to scan teeth and create a 3D model of the patient's dental anatomy. Typically, this process involves taking photographs or digital scans of the patient's teeth and surrounding structures using specialized dental imaging equipment. This information is then processed using computer software to create a 3D model that can be manipulated and customized to show the desired cosmetic changes to the teeth. The dentist can use this model to plan and design the appropriate cosmetic dental treatments, such as veneers or orthodontics, to achieve the desired aesthetic outcome for the patient. This process helps to ensure precise and accurate treatment planning, resulting in a more predictable and satisfactory outcome for the patient. The following are non-limiting examples of scanners that may be utilized herewith: Planmeca Emerald S by Planmeca Oy Asentajankatu 6, 00880 Helsinki, Finland (The Planmeca Emerald S is an intraoral scanner that provides high-quality 3D scans of teeth and surrounding tissue. It uses a unique continuous scanning technology to capture accurate and detailed images quickly and easily. The scanner is compatible with a range of dental procedures, including restorative work, orthodontics, and implant planning.); Dental Wings Virtuo Vivo by Dental Wings, 88 Prince St, Montreal, QC H3C 2M7, Canada (The Dental Wings Virtuo Vivo is an intraoral scanner that captures 3D scans of teeth and gums. It uses a high-speed camera to capture detailed images quickly and accurately. The scanner is compatible with a range of dental procedures, including restorative work, orthodontics, and implant planning.); and Carestream CS 3600 by Carestream Dental, 3625 Cumberland Blvd SE, Atlanta, GA 30339, United States (The Carestream CS 3600 is an intraoral scanner that captures high-resolution 3D scans of teeth and gums. It uses an intelligent matching system to ensure accurate and consistent scans. The scanner is compatible with a range of dental procedures, including restorative work, orthodontics, and implant planning.)

Further, a design may be made of the teeth 102 with wax to simulate a finished product. Such may be accomplished by taking impressions of the patient's teeth using a dental putty or other impression material. These impressions capture the unique shape and contours of the patient's teeth and are used as a reference for creating the wax model. Next, one may pour dental stone or other dental material into the impression to create a replica of the patient's teeth. This replica is then used as a base for creating the wax model. The wax model is created by sculpting melted wax onto the replica of the teeth, using the dental stone as a guide. The wax is carefully shaped and carved to create the desired shape, size, and position of the teeth. This process may involve multiple iterations to achieve the desired result. Once the wax model is complete, it can be used as a template for creating temporary restorations or as a reference for designing permanent restorations, such as crowns or veneers. The wax model is typically used in conjunction with digital imaging technologies, such as 3D scanning and CAD/CAM software, to create a precise and accurate representation of the desired final outcome of the cosmetic dental procedure.

Oftentimes, a requirement for typical dental veneers is to do the teeth in sets, such that 8-12 or more teeth are all done simultaneously such that the results are all consistent. Otherwise, a single veneer oftentimes looks out of place, and can have a disadvantageous cosmetic effect. Advantageously, with the method described herein, a singular tooth may be repaired and/or touched up such that is matches the surrounding teeth and there is significant difficulty distinguishing the repaired or touched-up tooth when compared to natural surrounding teeth.

The gums 104 and gumline 106 are measured along with the teeth 102, such that a proper mold may be made and the matrix 108 may be custom made. The gums are pushed back by the matrix 108 such that when it is time to add material, it may be added below the gumline 106.

The matrix 108 is generally a thin plastic or cellulose strip or band which is flexible and adaptable to the surface of the tooth 102 it is being placed around, such that the anatomical contours of the tooth 102 may be reproduced. In an exemplary embodiment, the matrix 108 is a BoPET material, or biaxially-oriented polyethylene terephthalate, such that the matrix is a high strength, chemically stable, transparent material. Further, this material allows the passage of photopolymerization light, which is helpful for curing materials such as resins on the teeth through the matrix. However, many other materials may be used. A few non-limiting examples of matrices used include but are not limited to: metals such as steel, bronze, titanium, plastics such as acetate and celluloid, and the like and combinations thereof.

The matrix 108 shown has been inserted around one of the teeth 102 such that it pushes the gums 104 back such that the gumline 106 is higher than normal. The matrix 108 is flexed around the contours of the tooth 102 such that a seal is made between the matrix 108 and the tooth 108. The matrix 108 is also shown flexed around the tooth 102 such that is fits along the sides of the tooth 102 and inserted between the teeth 102 such that one of the teeth 102 is completely isolated from the front from the other surrounding teeth 102. Accordingly, this allows work to be done on the tooth 102 without the surrounding teeth 102 being affected.

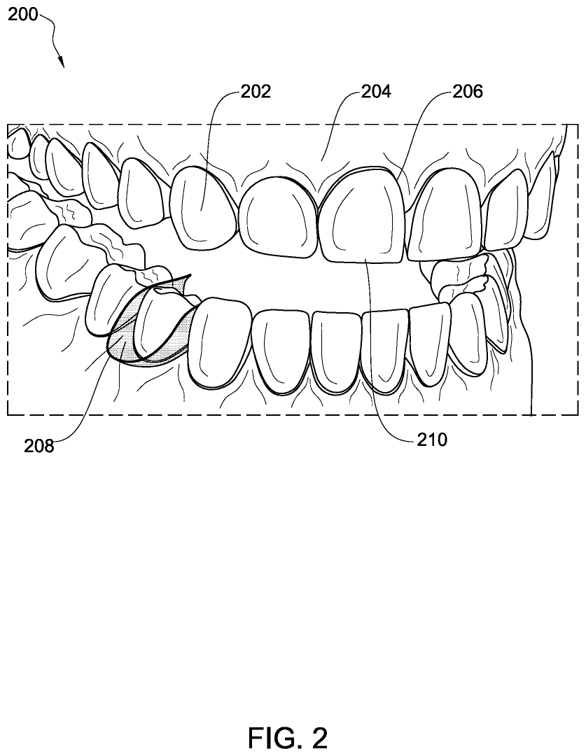

FIG. 2 is a side perspective view of teeth with overbuilt resin ready for the cutback step, according to one embodiment of the invention. As shown, there is a mouth 200 of the patient, the mouth containing multiple teeth 202, the gums 204, the gumline 206, a matrix 208, and unfinished tooth surfaces 210.

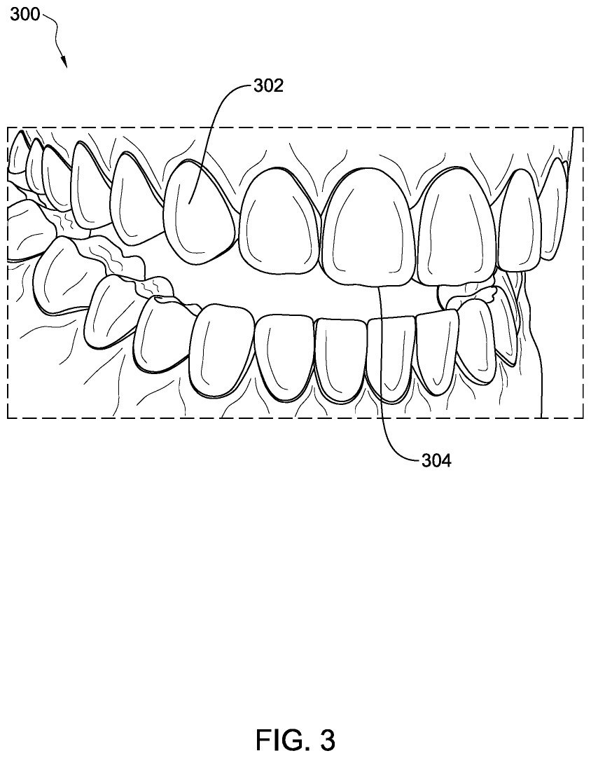

The teeth 202 are shown built up with a cured resin, such that they are bulkier and have a shape different than the finished veneer will have (e.g. the bottom of the two front teeth are overbuilt to be linear as compared to a more natural curvature of teeth, See FIG. 3, additionally the illustrated incisor is blocky and does not have the same pointed structure that is shown in the same tooth in FIG. 3). The teeth 202 may not always look significantly different than the finished product at this point, however depending on the work necessary for the tooth 202, there may be significant differences. Here, the difference has been exaggerated to show that there was material added to some of the teeth 202.

It may be that each tooth 202 in need of a veneer is built up one at a time, such that only one matrix 208 is in place at any moment. Accordingly, all the teeth 202 in need of a veneer are built up prior to any finishing work being done on any of the teeth 202. Often, the built-up resin is very close to the finished product, and the patient is given some time to determine whether the teeth 202 look and feel correct before final touch-ups are done. However, in other embodiments, the teeth 202 may be finished immediately after the resin is cured.

Such curing may occur using a dental curing light, which emits a specific wavelength of light that activates the photo-initiators in the resin. The photo-initiators in the resin start a chemical reaction that causes the resin to harden and bond to the tooth structure. Curing lights generally used in cosmetic dentistry are typically an LED or halogen light, which emits a blue light in the range of 400 to 500 nanometers. The light is directed at the resin material for a specific amount of time, typically 20 to 40 seconds, depending on the type and thickness of the resin being used. This exposure to the curing light activates the photo-initiators in the resin, initiating the chemical reaction that causes the resin to harden and bond to the tooth structure. The resin material used in cosmetic dentistry is generally formulated to be light-cured. This means that the material will not harden until it is exposed to a specific wavelength of light, such as the light emitted by a dental curing light.

Several types of resin materials are generally used in cosmetic dentistry, including composite resin, porcelain, and resin-modified glass ionomer cement (RMGIC). Composite resin is a tooth-colored plastic material that is used for a variety of cosmetic dental procedures, including dental bonding, tooth-colored fillings, and veneers. It is composed of a mixture of synthetic resins and fillers, such as glass or quartz that are bonded to the tooth using a dental adhesive. Composite resin can be color-matched to the surrounding teeth, making it an ideal material for creating natural-looking dental restorations. Porcelain is a type of ceramic material that is commonly used in cosmetic dentistry for veneers, crowns, and bridges. Porcelain restorations are highly durable and resistant to staining, and they can be color-matched to the surrounding teeth. Porcelain restorations require multiple dental appointments, as they are custom-made in a dental laboratory and then bonded to the teeth using a dental adhesive. Resin-modified glass ionomer cement (RMGIC) is a type of dental cement that is commonly used in cosmetic dentistry for restorations such as dental fillings and crowns. It is a mixture of glass ionomer cement and composite resin, which combines the benefits of both materials. RMGIC bonds chemically to the tooth structure and releases fluoride over time, which can help to prevent tooth decay.

The gums 204 and gumline 206 are shown with built-up resin underneath a small amount. Such that the strength of the repair extends past the visible tooth 202. This also helps with staining and consistency of the future result, as the entire face of the tooth 202 will be the same material instead of having the surface of the tooth be part resin and part tooth enamel. The gums 204 are allowed to relax once the matrix 208 is removed from the tooth 202.

The matrix 208 is shown on a tooth 202 ready for resin to be applied. The matrix 208 can be seen extending completely along the side of the tooth 202 such that there is matrix 208 completely separating the teeth 202. The matrix 208 is oftentimes left in place while the resin cures, however in some cases may be removed prior to curing, especially in cases where the matrix 208 does not allow photopolymerization light to pass through and into the resin.

The teeth 202 include unfinished tooth surfaces 210 which are shown exaggerated and in an unnatural looking manner. The unfinished tooth surfaces 210 generally include the front surface of the tooth 202, the sides of the tooth 202, and the top and/or bottom of the tooth 202, however in other embodiments may include only one side or any combination of sides. In some embodiments, the unfinished tooth surface may include the back surface of the tooth.

Oftentimes, this is not what the unfinished tooth surfaces 210 look like, as the tooth 202 will look very close to what the final result will be at this point, with a small amount of touch up. For example, the unfinished tooth surfaces 210 may be not entirely match the surrounding natural teeth, and such irregularities will be corrected at a later point.

FIG. 3 is a side perspective view of teeth shaped naturally after the cutback step, according to one embodiment of the invention. As shown, there is a mouth 300 of the patient, the mouth 300 containing multiple teeth 302 which include finished tooth surfaces 304.

As shown, the teeth 302 have had some of the resin removed and therefore have been slimmed down slightly into a less bulky and more natural look. In order to get that look, the resin on the teeth 302 may be cut back not only on the front-facing surface, however they may also be cut back on the sides of the teeth 302 as well as the tops and/or bottoms.

The teeth 302 include finished tooth surfaces 304 which are shown in a natural looking manner. The finished tooth surfaces 304 generally include the front surface of the tooth 302, the sides of the tooth 302, and the top and/or bottom of the tooth 302, however in other embodiments may include only one or any combination. In some embodiments, the unfinished tooth surface may include the back surface of the tooth 302. The finished tooth surfaces are carefully created such that they are comfortable and do not mess with the bite of the teeth 302.

The finished tooth surfaces 304, should look very similar if not identical to what the surrounding teeth 302 look like. Further, the finished tooth surfaces 304 usually will have an additional layer or layers of resin added to help seal the tooth 302 and create a color, polish, and stain stable exterior, however this may not be the case in all embodiments.

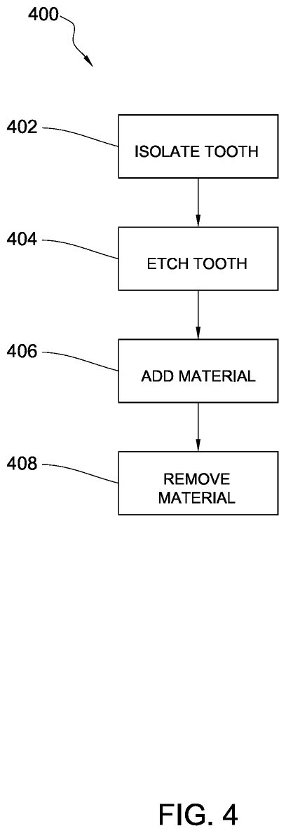

FIG. 4 is a flowchart of a method for non-invasive veneers, according to one embodiment of the invention. As shown, the method for non-invasive veneers 400 includes the steps of isolating the tooth 402, etching the tooth 404, adding material 406, and removing material 408. Advantageously, such a method for non-invasive veneers 400 does not require significant cutting and filing of the teeth. Further, the method for non-invasive veneers 400 creates a durable and imperfection resistant veneer in a field where such results are atypical.

The step of isolating the tooth 402 includes the prep work before any actual material is added and/or removed from the tooth. As such, the step of isolating the tooth 402 includes taking measurements of the teeth and gums to determine the bite of the teeth, the biting force of the teeth, and the tooth dimensions as well as measurements of the gums. However, in some embodiments, there may be little or no prep work necessary, such that the step of isolating the tooth 402 may include simply isolating the tooth from surrounding teeth such that when subsequent work is performed on the tooth, it does not affect the gumline or surrounding teeth.

Further, the step of isolating the tooth 402 includes a scan taken of the upper and lower teeth. Such a scan is important such that an accurate mold of the upper and lower teeth may be made. Once a mold is made, a design may be created on the tooth model with wax in order to determine how the buildup on the real teeth may take place. Further, putty may be taken and pressed against the mold to get a blueprint of the teeth such that material is added in the correct location and in the correct amounts such that the teeth are not overbuilt. In some embodiments, there may be other backings for the teeth used such that a mold is not necessary to add the correct amount of material and/or place the material in the correct location.

Additionally, the step of isolating the tooth 402 includes the step of using the measurements to create a custom matrix. The matrix is created to fit below the gumline and to isolate the tooth from the gumline as well as the surrounding teeth. This ensures there is a seal such that the gumline and the surrounding teeth are protected from the resin and are not stained or otherwise modified during the process on the specific tooth. Generally, matrices of all the teeth that are to have veneers are created during the step of isolating the tooth 402, such that no modifications are necessary when it comes time to create the veneers. In some embodiments, there may be matrices that are already ready for the majority of common tooth measurements, such that the matrices do not need to be custom created for each patient. Such an embodiment allows the matrices to simply be grabbed and placed into position.

Once the matrices are ready, the step of isolating the tooth 402 includes placing the matrices around the tooth. Such a step is generally done one matrix at a time; however there may be embodiments where multiple matrices may be placed simultaneously. The matrices are placed and bent around the tooth such that they isolate the tooth from the gums and the surrounding teeth. In some embodiments, tape may be used with or in place of the matrices, and in other embodiments, the matrices may not be needed at all, rather the step of adding material 404 may be done partially or in full without isolating the teeth.

Advantageously, the step of isolating the tooth 402 gets all the prep work out of the way such that when it is time to remove and/or add material to the teeth, the focus can remain on doing so. Further, the step of isolating the tooth 402 is important such that the results are confined to the desired tooth.

The step of etching the tooth 404 includes the final prep work after the tooth is isolated, however before material is added to the teeth. Generally, the step of etching the tooth includes cleaning the tooth and etching the enamel such that the resin forms a strong bond with the enamel of the tooth. However, in some embodiments, one or both of these steps may not be necessary.

The step of cleaning the tooth 404 includes removing material from the tooth such that the only remaining material on the teeth is the enamel of the teeth. In cases where teeth have had prior dental work conducted, the previously conducted dental work may remain intact or may be removed partially or in full. Once the tooth is cleaned, the tooth is dried such that it is ready to be etched.

The step of cleaning the tooth 404 further includes etching the tooth such that a strong bond is achieved between the tooth and the resin. The etching process is sometimes completed with a mechanically abrasive rotary tool. During the etching process, a tiny amount of material from the enamel is removed from the front surface of the tooth. In some embodiments, the enamel may be removed from the back, top, bottom, or sides of the tooth as well. The amount of material removed is generally much less than the amount removed when making standard porcelain veneers, such that discomfort or pain to the process as well a future sensitivity to temperature changes is minimized. Once the material is removed, the tooth may be cleaned again.

Often teeth are etched with an acidic solution, typically phosphoric acid, to prepare the enamel surface for bonding with resin. The process of etching creates microscopic pores on the surface of the enamel, which allows the resin to penetrate and bond more effectively. Etching also removes the surface layer of the enamel, creating a rough surface that provides mechanical retention for the resin. The process of etching begins with the isolation of the tooth being treated. The dentist will place a rubber dam or cotton rolls around the tooth to keep it dry and free from saliva. Then, the dentist will apply the etching solution, typically a 35% phosphoric acid solution, to the enamel surface for a specific amount of time, usually 15 to 30 seconds. During this time, the phosphoric acid solution dissolves the minerals on the surface of the enamel, creating the microscopic pores. The etching solution is then rinsed off with water and the tooth is dried thoroughly.

After etching, the tooth surface may be treated with a bonding agent, which is a type of dental adhesive that helps to improve the bond between the resin and the tooth. The bonding agent is applied to the etched enamel surface and then cured with a dental curing light. One common type of bonding agent is called an etch-and-rinse adhesive. This type of adhesive is applied after the etching process and is designed to infiltrate and wet the microscopic pores created by the acid. Etch-and-rinse adhesives typically contain solvents that help to dissolve and remove the water from the surface of the enamel, creating a more stable bond between the tooth structure and the composite resin material.

Another type of bonding agent is called a self-etch adhesive. This type of adhesive combines the etching and bonding steps into a single application. Self-etch adhesives use acidic monomers to etch the tooth surface and simultaneously create a chemical bond between the tooth structure and the composite resin material.

A third type of bonding agent is called a universal adhesive. Universal adhesives can be used in both etch-and-rinse and self-etch modes, providing dentists with more flexibility in their bonding approach. Universal adhesives typically contain a combination of acidic and hydrophobic monomers that help to improve the bond strength and durability of the composite resin material.

The following are non-limiting examples of bonding agents that may be used herewith: OptiBond XTR—Kerr Dental, 1717 W. Collins Ave, Orange, CA 92867, USA; Scotchbond Universal Adhesive—3M ESPE Dental Products, 3M Center, St. Paul, MN 55144-1000, USA; Adper Single Bond 2-3M ESPE Dental Products, 3M Center, St. Paul, MN 55144-1000, USA; Clearfil SE Bond-Kuraray America Inc., 2625 Bay Area Blvd, Suite 600, Houston, TX 77058, USA; and Prime&Bond Elect-Dentsply Sirona, 221 West Philadelphia Street, Suite 60W, York, PA 17401, USA.

In some embodiments, the step of cleaning the tooth 404 may include adding an adhesive to the tooth. Such a step may be done in conjunction with the etching process, with the etching creating a better substrate for the adhesive to bind to. In other embodiments, the adhesive may be in place of the etching such that no material is required to be removed from the tooth.

The step of adding material 406 includes using a putty mold behind the teeth to create an outline of the length and thickness at the bottom of the tooth. The putty mold is used to ensure that the resin layer will be approximately 1.5-2 mm in areas to create and mimic the natural strength of the teeth. However, not all embodiments will use the putty mold, and not all embodiments require 1.5-2 mm of resin, some may require less and others more depending on the tooth structure and state.

The step of adding material 406 includes adding a resin to the surface of the tooth. Generally, a composite resin is used, such a composite resin being curable rapidly via a photopolymerization light. However, in other embodiments, other resins, composites or not, may be used, such resins may be self-curing. Generally, the resin is heated prior to application on the teeth which seems to help strengthen the finished tooth. Typical veneer processes do not heat the material, and rely solely on the curing process of the resin for strength which seems to weaken the final product. In some cases, the material is heated to temperatures as high as 68C prior to being placed on the tooth, however heating is not always required.

The step of adding material 406 further includes the resin being applied in a single layer, as opposed to typical veneer processes which apply multiple thin layers. The resin is chosen due to its strength as well as its polish and color stability characteristics. In some embodiments, the resin is added in a particular manner, such that resin is added to the bottom of the tooth first, then to the sides of the teeth, followed by the gumline and the front surface of the tooth. In other embodiments, the order does not matter, and others even have the resin added to all sides at once. Care is taken at the division line between teeth such that the depth is managed, and a natural or otherwise normal look is subsequently achieved.

The resin is applied such that the tooth ends up bulkier than desired, such that a cutback process is necessary to help finish the tooth, such as providing depth and color. Efforts are made such that the tooth isn't made overly bulky at this stage. This is completely opposite to the existing methods of creating a veneer.

The typical veneer method is to build up gradually to the final desired shape and then to stop building up once the final intended shape is reached, wherein the final product is complete once the resin is cured, not allowing further modifications.

The step of adding material 406 includes curing the resin. A photopolymerization light is used to help speed up the curing process, and the curing process may take place with or without the matrix and/or putty mold in place. The material is generally cured after application, such that if resin is added to the bottom of the tooth first, it is cured prior to applying resin to the sides of the tooth, however in some embodiments curing takes place all at once.

Experiments have gleaned that that the typical photopolymerization light which helps bond the resin to the teeth is approximately 70% of the full linkage and strength. The addition of the heating prior to application and heating individual tooth applications wherein there is a short period of time between heating and application, such that the bond happens while hot, rather than a batch where cooling takes place prior to bonding, may increase such a result to 90%.

The step of removing material 408 includes an initial removal of material after the resin is cured. An abrasive rotary tool is used to remove the initial material, as well as introduce heat to the resin which performs a second hardening step during the removal process. This frictional removal and the heat thereby generated within the remaining resin, based on the inventors experimentation, creates a stronger material that allows a better polish and withstands normal use better, resulting in far fewer cracks and chips later for the patient than what is experienced by patients who have veneers made using the typical process of gradually building up layers to an intended shape. A purpose of the frictional removal of material is to achieve the final desired shape (or close thereto) and ensure the tooth fits the patient prior to complete finishing. Once the initial removal is complete, the shape is tested to ensure it not only looks accurate, however the teeth are balanced as well as at the desired level of functionality and comfort.

Once the initial cutback is complete, a secondary cutback may be done immediately after, or there may time in between to help ensure the initial shaping has been completely correctly. The secondary cutback includes mechanical abrasion to remove a measured amount of the cured resin. The amount of removal is measured using the thickness of the abrasive burr used. Oftentimes the secondary cutback is deeper into the material such that the tooth becomes smaller than the desired finished tooth. The secondary cutback may include specific cutting done to add effects and/or coloration to provide depth and match the tooth to the surrounding teeth.

Once the secondary cutback is complete, a final layer of aesthetic resin (i.e. a resin having the desired coloring/translucency/etc.) is added to the tooth such that the aesthetic effects are covered and will last. Generally, the final layer of resin will be a thin layer which builds up the tooth once again such that it the desired size, and the final later of resin will be translucent in order to provide depth to the tooth, however in other embodiments this may not be necessary. The resin used may be structurally different than the resin used to build will be used. Such a resin may be slightly weaker than the resin previously applied, however may be used due to increases in the stain resistance and polishing capabilities. In other embodiments, a similar resin to the first application may be used such that the entire built-up tooth has the same physical characteristics.

Once the final layer of resin is applied, the tooth is checked for both fitment and cosmetic issues. Any remaining shaping is then completed, and the tooth is polished such that it matches the surrounding teeth.

Advantageously, such a method for non-invasive veneers 400 is an overbuild and removal process, rather than solely a build-up process. Accordingly, the method allows for a much stronger finished veneer which is not only more resistant to damage, however is also far more stain resistant than typical veneer applications. Additionally, the method allows far more customization of shape, color, and depth effects, such that the teeth look more natural.

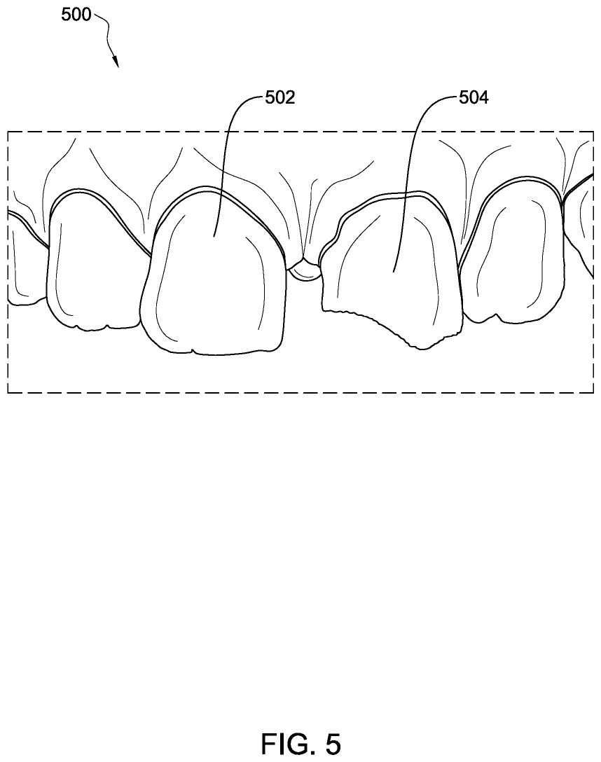

FIG. 5 is a front elevational view of teeth prior to veneers, according to one embodiment of the invention. As shown, there is a mouth 500 of the patient, the mouth 500 containing multiple teeth 502 which include a tooth with visible damage or discoloration 504. Advantageously, the method herein may be used to correct such damage or cosmetic imperfection on a single tooth 504, even if the damage is significant and/or on an outer edge of the tooth 504.

As shown, there is a tooth which includes visible damage 504 compared to the surrounding teeth 502. Even in such a scenario, the process defined above may be followed to make such a drastic repair. First, a mold is taken of the the damaged tooth 504, and a matrix is custom created to fit the damaged tooth 504. Then, the damaged tooth 504 is isolated from the remaining teeth 502 via a matrix. In such a case, a backing may be necessary to fill the missing portion of the tooth prior to curing. Such a backing may be the mold previously created, or may be a customized to fit the back surface of the damaged tooth 504.

Once the damaged tooth 504 is isolated from the surrounding teeth 502, the damaged tooth 504 may be etched ever so slightly to ensure resin adhesion and may have some additional damaged sections trimmed such that the resin has a stable and solid foundation to adhere to. Afterwards, the resin is layered on and cured, and the backing and matrix are removed from the damaged tooth 504, leaving the damaged tooth 504 with overbuilt and unfinished resin.

Once the resin is cured, the overbuilt damaged tooth 504 is cut back with a mechanical abrasive method which further cures the resin and helps shape the damaged tooth 504 and provide depth such that the resin finish matches the unique imperfections of the surrounding teeth 502. Once the damaged tooth 504 is finished being cut back, a final layer of resin is added to help seal the damaged tooth 504 as well as create a polish and color-stable finish. A final polish may be conducted if necessary or otherwise desired.

Such a process is significantly different than a normal veneer process. In a typical veneer process, the damaged tooth 504 would have significant amounts of material removed in order to prepare it. Accordingly, large amounts of enamel, and sometimes even dentin, are permanently removed. This results in the natural tooth being incredibly vulnerable, and restoration of the natural tooth is impossible once such damage is done. Such a process often causes discomfort or significant pain to the patient and in some cases may even require local and/or general anesthesia.

Next, a porcelain veneer made and placed over the damaged tooth 504 like a shell, or in a resin method would have small layers of resin added one at a time. The layers of resin would each be mixed and applied one at a time in an attempt to match the color, shape, and imperfections of the surrounding teeth 502. Once the porcelain veneer or final layer of resin is added, the results are final and are no longer changed, often resulting in subpar results.

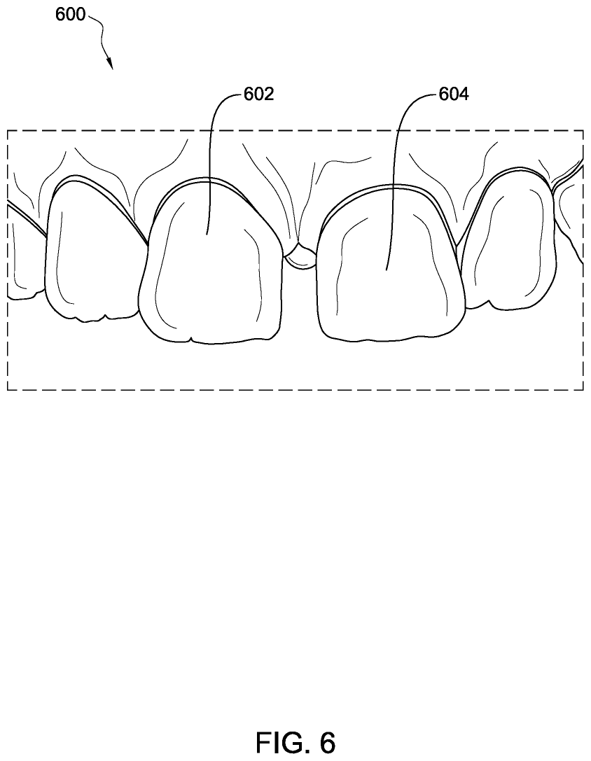

FIG. 6 is a front elevational view of teeth after veneers, according to one embodiment of the invention. As shown, there is a mouth 600 of the patient, the mouth 600 containing multiple teeth 602 which include a repaired tooth 604 with no more visible damage or discoloration. Advantageously, the method herein may be used to correct such damage or cosmetic imperfection on a single tooth 604, such that the finished result is indistinguishable from the surrounding teeth 602, even when the veneer is placed only on the damaged tooth 604.

As shown, there is a repaired tooth 604 which no longer includes visible damage. The repaired tooth 604 matches the shape and unique characteristics of the surrounding teeth 602 is polish and color stable, as well as stain resistant. Further, the repaired tooth, due to the unique overbuilding, heat treatment, and cut back method, is a more permanent fix, and should be similar in strength to the surrounding natural teeth such that the user does not experience breakage. Further, since the natural tooth was kept as whole as possible, the repaired tooth 602 is less likely to have lingering discomfort or have sensitivity to temperature fluctuations.

Such results are significantly different from typical veneer results. For porcelain veneers, the shell often does not match surrounding teeth 602, and it may be recommended to add veneers to surrounding teeth 602. For other composite veneers, the layering may make the tooth 604 susceptible to cracking or breakage as well as staining. In either case, other veneers are permanent, and restoration to the natural tooth is no longer possible. Further, the build-up veneer methods may create imbalanced bites and unnatural or bulky appearances.

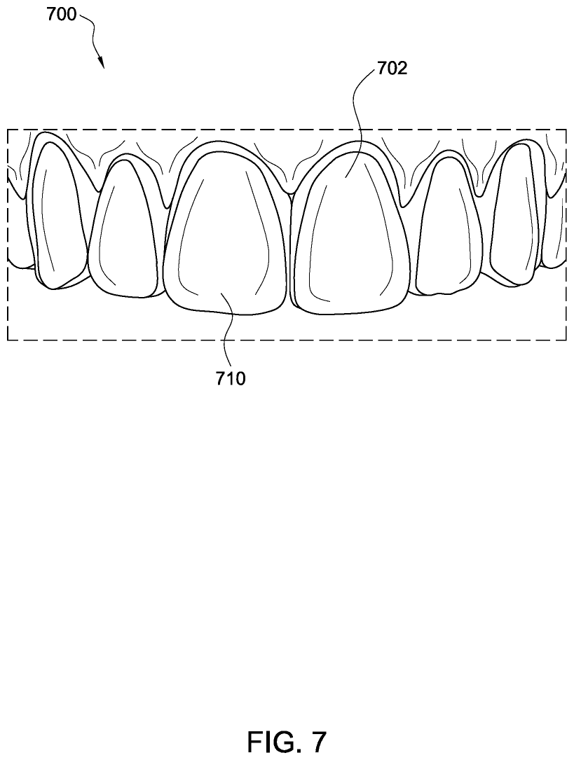

Looking to FIGS. 7-14, the following additional steps are illustrated:

FIG. 7 illustrates a front elevational view of teeth, showing a step of an initial frame after a first overbuild, according to one embodiment of the invention. As shown, there is a mouth 700 of the patient, the mouth containing multiple teeth 702, and an unfinished tooth surface 710. The unfinished tooth surface 710 is shown built up with a cured resin, such that it is bulkier and has a shape different than the finished veneer will have.

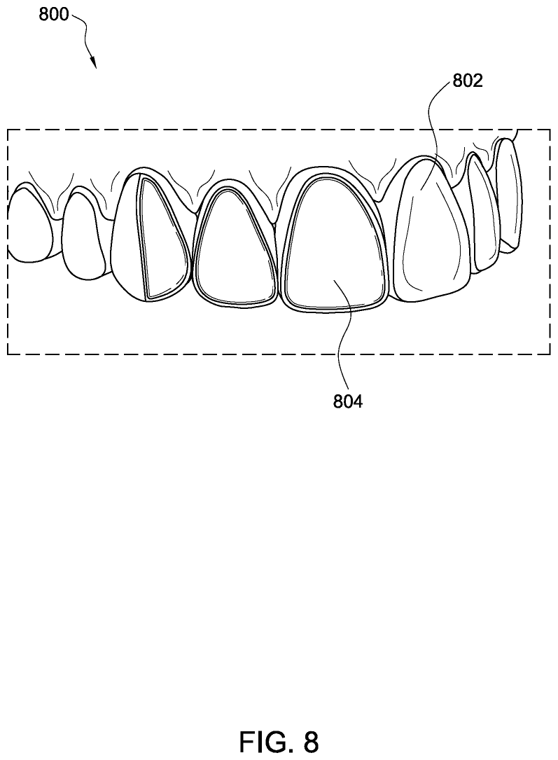

FIG. 8 illustrates a side perspective view of teeth, showing a step of a first cut back, according to one embodiment of the invention. As shown, there is a mouth 800 of the patient, the mouth 800 containing multiple teeth 802 which include initial cutback tooth surfaces 804. As shown, the teeth 802 have had some of the resin removed and therefore have been slimmed down slightly into a less bulky and more natural look. In order to get that look, the resin on the teeth 802 may be cut back not only on the front-facing surface, however they may also be cut back on the sides of the teeth 802 as well as the tops and/or bottoms.

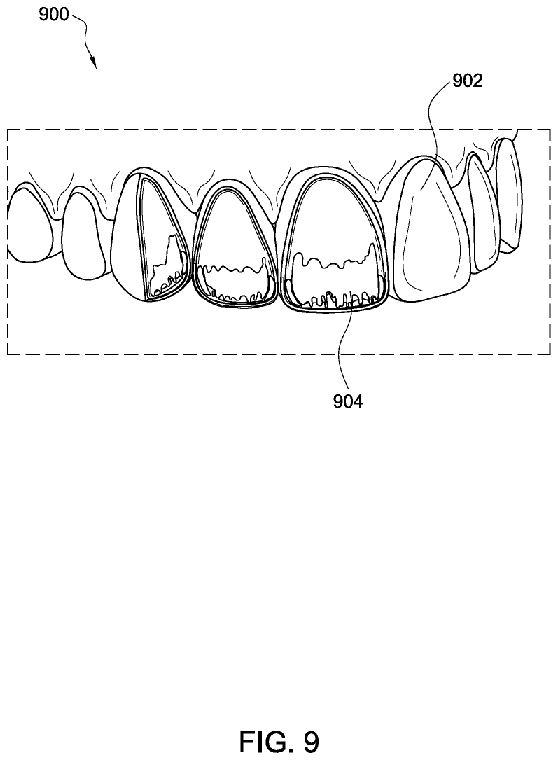

FIG. 9 illustrates a side perspective view of teeth, showing a step of added tints and natural effects, according to one embodiment of the invention. As shown, there is a mouth 900 of the patient, the mouth 900 containing multiple teeth 902 which include tooth surfaces 904. Tints and other effects and/or coloration may be added to a tooth surface 904 such as by a secondary cutback. In one embodiment, a secondary cutback may include specific cutting done to add effects and/or coloration to provide depth and match a tooth surface 904 to the surrounding teeth 902.

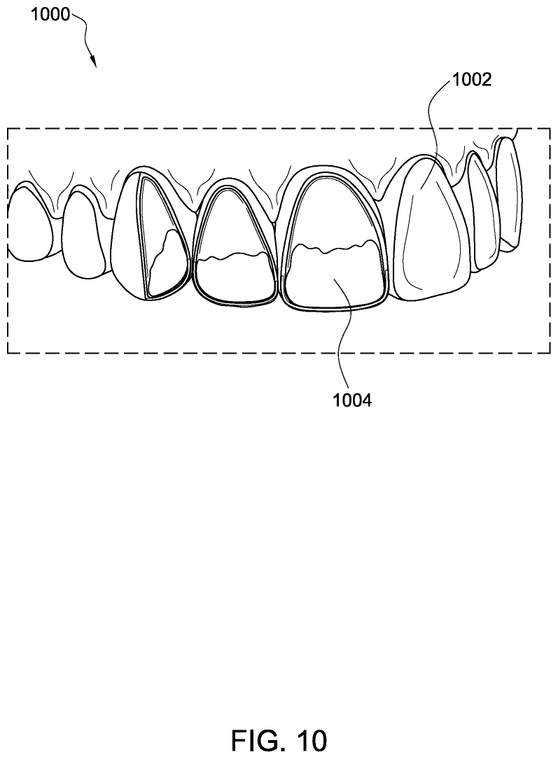

FIG. 10 illustrates a side perspective view of teeth, showing a step of a filter composite placed over tints, according to one embodiment of the invention. As shown, there is a mouth 1000 of the patient containing multiple teeth 1002 which include tooth surfaces 1004. The composite may be placed over tints on a tooth surface.

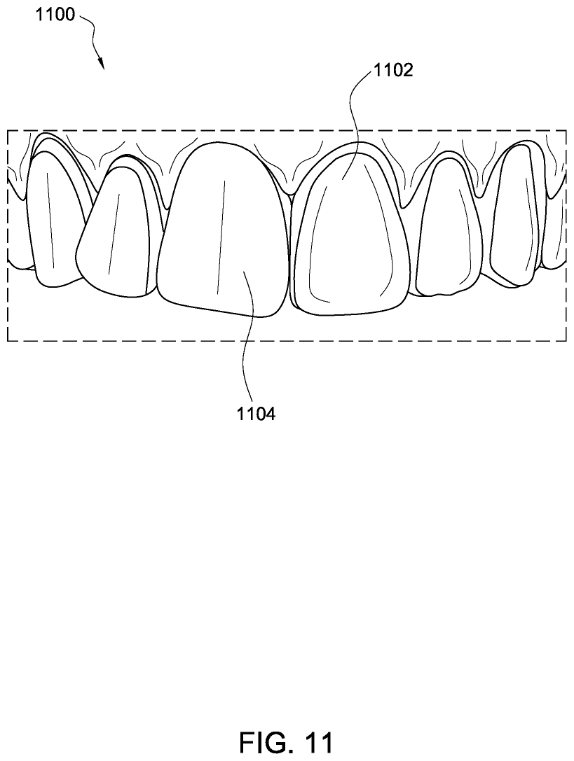

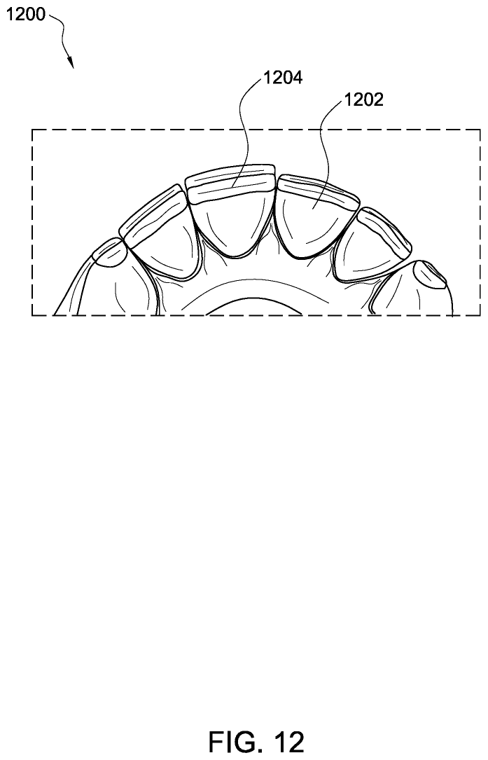

FIGS. 11 and 12 illustrate a front elevational view of teeth, and a bottom plan view of teeth, respectively, showing a step of an overbuild of a clear layer, according to one embodiment of the invention. As shown, there is a mouth 1100 and 1200 of the patient, the mouth 1100 and 1200 containing multiple teeth 1102 and 1202 which include tooth surfaces 1104 and 1204. A final layer of aesthetic resin (i.e. a resin having the desired coloring/translucency/etc.) is added to a tooth 1102 and 1202 such that the aesthetic effects are covered and will last. Generally, the final layer of resin will be a thin layer which builds up the tooth surface 1104 and 1204 once again such that it the desired size, and the final later of resin will be translucent in order to provide depth to the tooth 1102 and 1202.

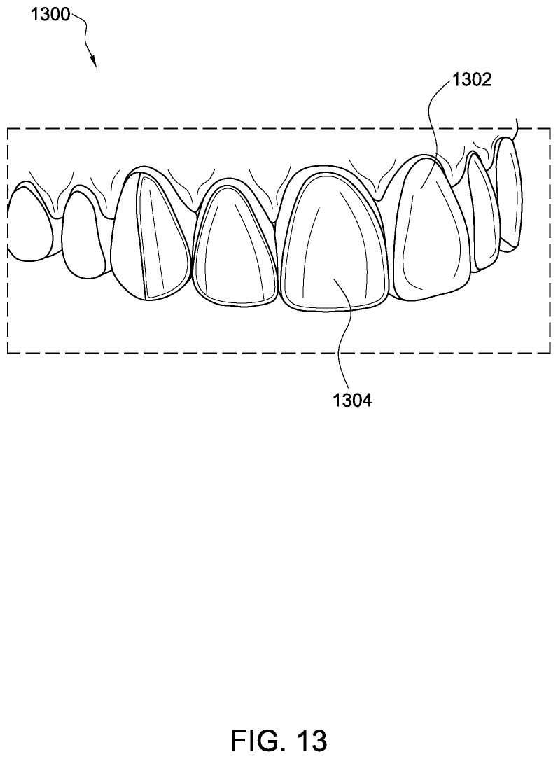

FIG. 13 illustrates a side perspective view of teeth, showing a step of final framing and shaping after an overbuild of a clear layer, according to one embodiment of the invention. There is shown a mouth 1300 with teeth 1302 having a tooth surface 1304. Once the final layer of resin is applied as shown in FIGS. 11 and 12, the tooth 1302 is checked for both fitment and cosmetic issues. Any remaining shaping is then completed to the tooth surface 1304.

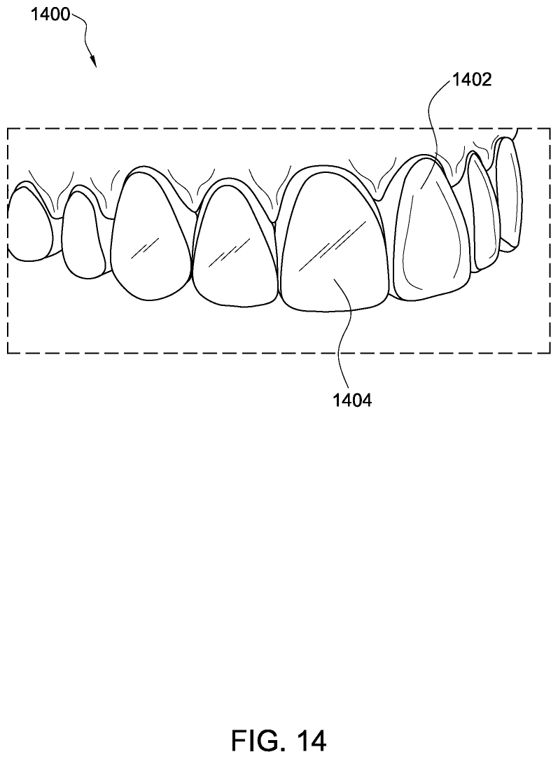

FIG. 14 illustrates a side perspective view of teeth, showing a step of a final finishing and polishing, according to one embodiment of the invention. The illustrated mouth 1400 include teeth 1402 with teeth surfaces 1404. A tooth surface 1404 may be polished such that the tooth surface 1404 matches the surrounding teeth 1402.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method for non-invasive veneers, comprising:
a. placing a transparent matrix around the front surface of a tooth, the matrix placed into the gingival sulcus and extending from the front surface of the tooth;
b. filling an interior of the matrix with a resin in an amount sufficient to overbuild the intended final shape of the tooth;
c. performing a first step of hardening the resin; and
d. shaping the tooth to its final intended shape by mechanically removing the resin by heat-inducing friction, thereby also performing a second step of hardening the resin that remains once the tooth is shaped to its final intended shape.

2. The method of claim 1, further including the step of adding a secondary layer of resin.

3. The method of claim 2, wherein the step of adding a secondary layer of resin occurs after the step of mechanically removing the resin.

4. The method of claim 1, wherein the method does not include a step of removing enamel of the tooth other than what is accomplished by surface etching.

5. The method of claim 1, further including the step of etching the tooth.

6. The method of claim 1, wherein the step of filling the interior of the matrix with a resin includes heating the resin immediately before application.

7. The method of claim 5, wherein the resin is heated to over 60 degrees Celsius.

8. The method of claim 1, further including the step of placing a putty mold behind the tooth.

9. The method of claim 1, wherein the step of filling the interior of the matrix with a resin is done in the order of: the bottom region of the tooth, the side regions of the tooth, the front surface of the tooth.

10. The method of claim 9, wherein the resin is cured after each application and prior to applying resin in the next region.

11. A method for non-invasive veneers, comprising:
a. placing a strip around the front surface of a tooth, such that the tooth is isolated from the surrounding teeth;
b. filling a portion of the interior of the strip with a resin;
c. curing the resin; and
d. mechanically removing the resin.

12. The method of claim 11, further including the step of adding a secondary layer of resin after the step of mechanically removing the resin.

13. The method of claim 12, wherein the step of mechanically removing the resin includes shaping the tooth into a desired shape.

14. The method of claim 13, wherein the step of mechanically removing the resin includes introducing heat to the resin.

15. The method of claim 14, wherein the step of filling the interior of the matrix with a resin includes heating the resin immediately before application.

16. The method of claim 15, wherein the step of filling an interior of the matrix with a resin includes overbuilding the resin on the tooth.

17. The method of claim 16, wherein the step of adding a secondary layer of resin includes wherein the resin used is a different resin than the resin previously applied.

18. The method of claim 17, wherein the strip is a clear BoPET matrix.

19. The method of claim 18, wherein the secondary resin is weaker than the resin previously applied, however is more polish and color stable.

20. A method for non-invasive veneers, comprising:
a. placing a clear matrix around the front surface of a tooth, the matrix placed into the gingival sulcus and extending from the front surface of the tooth;
b. adding a primary layer of resin to the tooth, the resin being heated prior to application and added to the tooth in the following order, each section of resin cured prior to adding resin in the subsequent region:
i. the bottom of the tooth;
ii. the side of the tooth; and
iii. the front surface of the tooth;
c. mechanically removing a portion of the primary layer of resin using an abrasive material in a manner that heats the resin during the removal thereof;
d. adding a secondary layer of resin, the secondary layer of resin being a different resin than previously applied; and
e. polishing the secondary layer of resin.
